(19) United States
(12) Patent Application Publication
(10) Pub. No.: US 2026/0017840 A1
(43) Pub. Date: Jan. 15, 2026

(54) SYSTEM AND METHOD FOR GENERATING A FACIAL IMAGE FROM A VOICE SAMPLE USING A STYLEGAN

(71) Applicant: Corsound AI Ltd, Tel Aviv (IL)

(72) Inventor: Ainur Mukhambetova, Kostanay (KZ)

(73) Assignee: Corsound AI Ltd, Tel Aviv (IL)

(21) Appl. No.: 18/772,339

(22) Filed: Jul. 15, 2024

(51) Int. Cl. G06T 11/00; G06V 10/74; G06V 40/16

(52) U.S. Cl. CPC G06T 11/00; G06V 10/761; G06V 40/172

(57) ABSTRACT

System and method for reconstructing a facial image of a speaker from a voice sample of the speaker may include providing the voice sample of the speaker to a trained voice encoder to generate a voice embedding of the speaker, wherein the voice encoder is trained to provide a voice embedding that matches an image embedding of the facial image of the speaker; providing the voice embedding of the speaker to a trained mapping network to generate an intermediate latent vector, wherein the mapping network is trained to generate an intermediate latent vector for a StyleGAN from the voice embedding; and providing the intermediate latent vector to the StyleGAN to generate the facial image of a speaker.

### FIELD OF THE INVENTION

The present invention relates generally to reconstructing a face from a voice sample. More specifically, the present invention relates to using StyleGAN to reconstruct a facial image of the speaker from a voice sample of the speaker.

### BACKGROUND

It has been shown experimentally that human appearances are associated with their voices. Specifically, some research suggests that there may be a connection between voice characteristics and the appearance of the speaker's face. For example, properties like age, gender, ethnicity, and accent may influence both the facial appearance and the voice. In addition, there exist other, more subtle properties that influence both the facial appearance and voice, such as the level of specific hormones, the shape of the mouth, facial bone structure, thin or full lips or the mechanics of speech production, which may affect both the sound of the voice and the visual appearance of the face of the speaker.

### SUMMARY

According to embodiments of the invention, a computer-based system and method for reconstructing a facial image of a speaker from a voice sample of the speaker may include: providing the voice sample of the speaker to a trained voice encoder to generate a voice embedding of the speaker, wherein the voice encoder is trained to provide a voice embedding that matches an image embedding of the facial image of the speaker; providing the voice embedding of the speaker to a trained mapping network to generate an intermediate latent vector, wherein the mapping network is trained to generate an intermediate latent vector for a StyleGAN from the voice embedding; and providing the intermediate latent vector to the StyleGAN to generate the facial image of a speaker.

Embodiments of the invention may include jointly training the mapping network, the voice encoder and an image encoder configured to generate an image embedding from a facial image, using a training dataset of matching and unmatching facial images and voice samples, where the voice encoder and the image encoder may be trained so that a distance between the voice embedding and the image embedding of a matching voice sample and facial image is less than the distance between the voice embedding and the image embedding of an unmatching voice sample and facial image.

According to embodiments of the invention, the mapping network may be trained to minimize a reconstruction loss between an input image and the generated facial image of a speaker.

According to embodiments of the invention, the reconstruction loss may include one or more of: a distance measure between the facial image provided to the image encoder and the reconstructed facial image, learned perceptual image patch similarity (LPIPS) loss and L_sim or Similarity loss.

According to embodiments of the invention, the voice encoder and the image encoder may be trained using a loss function that decreases a distance between the voice embedding and the image embedding of the matching voice sample and facial image, and increases a distance between the voice embedding and image embedding of the unmatching voice sample and facial image.

According to embodiments of the invention, jointly training the voice face matching network and the mapping network may include training one of the voice face matching network or the mapping network in a single training step, and deciding, for a specific training step, whether to train the voice face matching network or the mapping network.

According to embodiments of the invention, the voice encoder may include a pretrained voice encoder and a trainable voice cross-modal encoder.

According to embodiments of the invention, the image encoder may include a pretrained image encoder and a trainable image cross-modal encoder.

According to embodiments of the invention, a computer-based system and method for reconstructing a facial image of a speaker from a voice sample of the speaker may include: obtaining a pretrained voice face matching network comprising a voice encoder configured to generate a voice embedding from a voice sample and an image encoder configured to generate an image embedding from a facial image that are trained so that a distance between the voice embedding and the image embedding of a matching voice sample and facial image is less than the distance between the voice embedding and the image embedding of an unmatching voice and facial image; training a mapping network to generate an intermediate latent vector for a StyleGAN from the image embedding generated by the image encoder, so that the StyleGAN would generate a reconstructed facial image; providing the voice sample of the speaker to the trained voice encoder to generate a voice embedding of the speaker; and providing the voice embedding of the speaker to the trained mapping network so that the StyleGAN would generate the facial image of the speaker.

According to embodiments of the invention, the mapping network may be trained to minimize a distance measure between the facial image provided to the image encoder and the reconstructed facial image.

According to embodiments of the invention, the mapping network may be trained using at least one of image reconstruction losses and pixel-wise distance between the facial image provided to the image encoder and the reconstructed facial image.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanying drawings. Embodiments of the invention are illustrated by way of example and not limitation in the figures of the accompanying drawings, in which like reference numerals indicate corresponding, analogous or similar elements, and in which:

FIG. 1 depicts a system for training a voice-face matching model and a mapping network, according to embodiments of the invention.

FIG. 2 depicts a system for training a voice-face matching model and a mapping network, according to embodiments of the invention.

FIG. 3 depicts a system for reconstructing a facial image of a speaker from a voice sample of the speaker, according to embodiments of the invention.

FIG. 4 depicts a system for reconstructing a facial image of a speaker from a voice sample of the speaker, according to embodiments of the invention.

FIG. 5 is a flowchart of a method for reconstructing a facial image of a speaker from a voice sample of the speaker, according to embodiments of the invention.

FIG. 6 is a flowchart of a method for jointly training a voice-face matching model and a mapping network, according to embodiments of the invention.

FIG. 7 depicts facial images reconstructed from a voice sample of the speaker, according to embodiments of the invention.

FIG. 8 shows a high-level block diagram of an exemplary computing device which may be used with embodiments of the present invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Embodiments of the invention may provide a system and method for generating a facial image of a speaker from a voice sample of the speaker using a style-based generator architecture for generative adversarial networks (StyleGAN).

Some practical applications examples of generating a facial image from a voice sample may include criminal investigations where a sample of the voice of a suspect is the only evidence: for example, the voice sample may be provided to the system that may provide an estimated image of the suspect. Another application may include authentication of users by service providers. For example a service provider may have a facial image database and may authenticate by voice.

Current voice to face reconstruction solutions may include the Speech2Face network, the speech fusion to face (SF2F) and a computational framework based on GANs. All these techniques, however, render limited image quality, and fall short in producing high-quality, detailed and realistic images.

A StyleGAN is a type of generative adversarial network (GAN) which provides unconditional image synthesis in high visual quality and fidelity compared to traditional GANs. While in a traditional GAN the latent vector is provided to the generator through an input layer, e.g., the first layer of a feedforward network, in a StyleGAN the input layer is omitted, and the network starts with a learned constant, referred to as the z E Z vector where Z is the latent space. Instead of using the latent space vector as input, the StyleGAN uses a mapping network to map or convert the latent space vector to an intermediate latent space vector w E W, where W is an intermediate latent space, and uses the intermediate latent space vector w to control style at each point in the generator model. StyleGAN may further use noise as a source of variation at each point in the generator model. While embodiments of the invention refer to StyleGAN, it is noted that other variations of StyleGAN, such as StyleGAN2, StyleGAN3 or other variations of StyleGAN may be used wherever StyleGAN is referred to.

Embodiments of the invention may use a StyleGAN (e.g., any variation of StyleGAN) to reconstruct an image of a speaker from a voice sample of the speaker. Thus, embodiments of the invention may improve the technology of reconstructing a face from a voice sample by providing photorealistic and high-quality reconstructed face images of the speaker, in detail and quality that is much higher than current voice to face reconstruction networks.

According to embodiments of the invention, a voice face matching network and a mapping network configured to provide an intermediate latent vector to a StyleGAN may be jointly trained using a training dataset of matching and unmatching facial images and voice samples, where the voice face matching network may include a voice encoder configured to generate a voice embedding from a voice sample and an image encoder configured to generate an image embedding from a facial image. The voice encoder and the image encoder may be trained so that a distance between the voice embedding and the image embedding of a matching voice sample and facial image is less than the distance between the voice embedding and the image embedding of an unmatching voice and facial image. The mapping network may be trained to generate the intermediate latent style vector for the StyleGAN from the image embedding or from the voice embedding, so that the StyleGAN would generate a reconstructed facial image. During inference, a voice sample of the speaker may be provided to the trained voice encoder to generate a voice embedding of the speaker; the voice embedding of the speaker may be provided to the trained mapping network to generate an intermediate latent vector w, and the intermediate latent vector w may be provided to the StyleGAN so that the StyleGAN reconstructs the facial image of the speaker (or an estimated image of the speaker).

According to embodiments of the invention, a voice encoder, an image encoder, a mapping network, StyleGAN, a GAN and other modules disclosed herein may include one or more neural networks (NN). NNs are computing systems inspired by biological computing systems, but operating using manufactured digital computing technology. NNs are mathematical models of systems made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning or training proceeds typically using a loss function. The weight increases or decreases the strength of the signal at a connection. Typically, NN neurons or nodes are divided or arranged into layers, where different layers can perform different kinds of transformations on their inputs and can have different patterns of connections with other layers.

NN systems can learn to perform tasks by considering example input data, generally without being programmed with any task-specific rules, being presented with the correct output for the data, and self-correcting, or learning using a loss function.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example time delay neural network (TDNN) which is a multilayer artificial neural network that can be trained with shift-invariance in the coordinate space.

In practice, a NN, or NN learning, may be performed by one or more computing nodes or cores, such as generic central processing units or processors (CPUs, e.g. as embodied in personal computers) or graphics processing units (GPUs), which can be connected by a data network.

For training the voice-face matching model, embodiments of the invention may use a plurality of data structures such as triplets, where each data structure or triplet includes at least a voice or speech sample of a first person, a facial image of the first person and a facial image of a second, different, person. Other types of triplet may be used, such as triplets including at least a voice or speech sample of a first person, a facial image of the first person and a voice or speech sample of a second, different, person. The facial images may be provided in any applicable computerized image format such as joint photographic experts group (JPEG or JPG), portable network graphics (PNG), graphics interchange format (GIF), tagged image file (TIFF), etc., and the voice or speech sample may be provided in any applicable computerized audio format such as MP3, MP4, M4A, WAV, etc.

Voice samples and facial images may be provided to a voice encoder and an image encoder, respectively, that may generate an embedding (e.g., a voice embedding or an image embedding), also referred to herein as a latent space vector, a representation, a feature vector, in a forward pass, for each of the voice samples and images. As used herein, an embedding, also referred to as a latent space vector, a signature or a feature vector, may include a reduced dimension (e.g., compressed) representation of the original data, generated for example by an ML model or an encoder. The embedding may include a vector or a matrix (e.g., an ordered list of values in any desired structure) that may represent the original data in a compressed form that, if generated properly, includes important or significant components or characteristics of the raw data.

Embodiments of the invention may use one or more loss functions, to train a voice encoder, the face encoder and the mapping network. A loss function may be used in the training process to adjust weights and other parameters in the voice encoder, the face encoder and the mapping network in a backpropagation or gradient descent process. The voice encoder and the face encoder may be trained to decrease the distance between the embeddings generated by the voice encoder and the image encoder for a voice sample and a facial image of the same person, and increase the distance between the embeddings generated by the voice encoder and the image encoder for a voice sample and a facial image of different persons. The distance between embeddings may be measured using any applicable distance metric such as the Euclidian distance, the inverse of the cosine similarity measure, or other distance metrics. A loss function may be used to train the mapping network so that the facial image generated by the StyleGAN will be similar to the facial image provided to the image encoder in the training process.

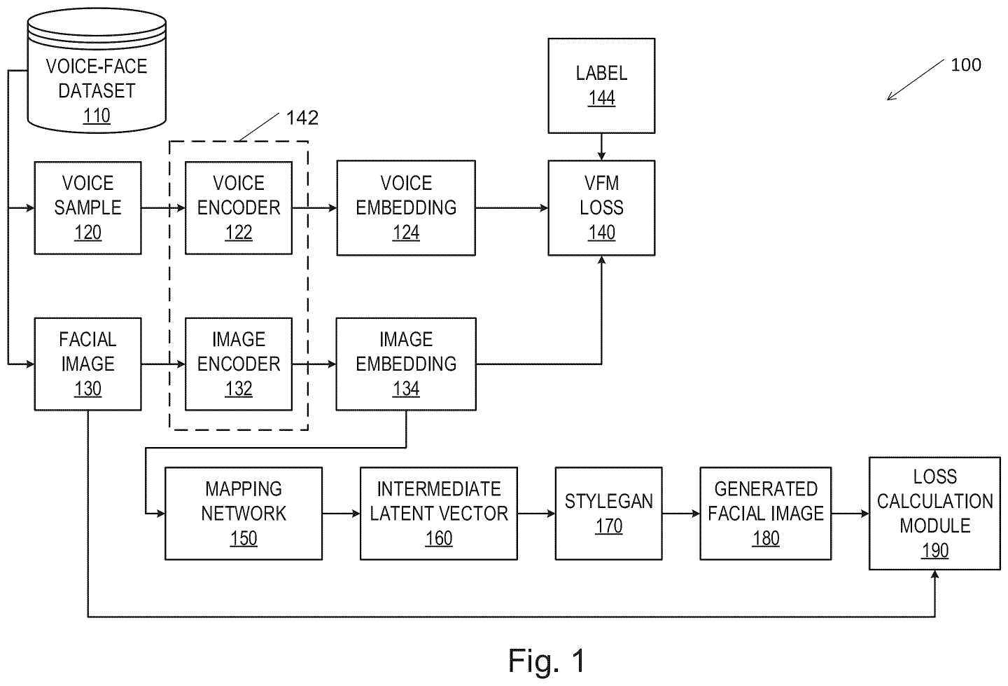

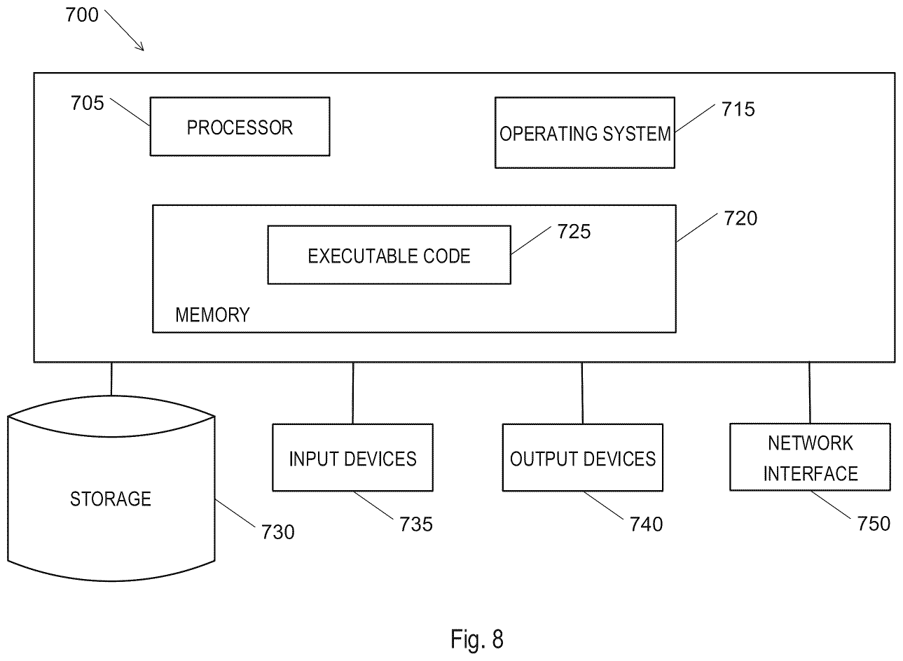

Reference is made to FIG. 1, which depicts a system 100 for training voice-face matching model 142 and a mapping network 150, according to embodiments of the invention. It should be understood in advance that the components and functions shown in FIG. 1 are intended to be illustrative only and embodiments of the invention are not limited thereto. While in some embodiments the system of FIG. 1 is implemented using systems as shown in FIG. 8, in other embodiments other systems and equipment can be used.

Voice-face dataset 110 may include pairs of matching voice or speech samples 120 and face images 130, e.g., voice samples and images of the same person. Voice-face dataset 110 may be stored, for example, on storage 730 presented in FIG. 8. It should be readily understood that while embodiments of the invention are described with reference to pairs or triplets, this this not limiting and other data structures, and datasets of voices and matching and unmatching images, may be used, with proper adjustments.

According to some embodiments of the invention, voice-face matching model 142 may include two subsystems also referred to herein as subnetworks or encoders, a voice encoder 122 and an image encoder 132. Each of voice encoder 122 and image encoder 132 may include an ML model, such as a NN, that may generate an embedding or a latent space vector for the input data. For example, voice encoder 122 may generate voice embedding 124, also referred to herein as a voice latent space vector, and image encoder 132 may generate image embedding 134, also referred to herein as image latent space vector.

For training voice-face matching model 142, voice-face matching model 142 may be provided with labeled pairs of matching voice or speech samples 120 and face images 130, e.g., voice samples and images of the same person, and pairs of unmatching voice or speech samples 120 and face images 130, e.g., voice samples and images of different persons. Label 144 of each pair voice sample 120 and face image 130 may indicate the ground truth of the pair, e.g., whether the pair includes matching or unmatching voice sample 120 and face image 130.

According to embodiments of the invention, VFM loss calculation module 140 may calculate a loss function, based on voice embedding 124, image embedding 134, the labels 144 indicating whether voice embedding 124 and image embedding 134 are of the same person or not. In some embodiments labels 144 may be calculated based on metadata of voice embedding 124 and image embedding 134, e.g., an identification number (ID) of the person associated with voice embedding 124 or image embedding 134. The loss function calculated by VFM loss calculation module 140 may be used to train voice-face matching model 142, e.g., voice encoder 122 and image encoder 132, in a backpropagation or gradient descent process, so that voice embedding 124 and image embedding 134 of a matching voice sample 120 and facial image 130 will be closer comparing to the voice embedding 124 and the image embedding 134 of an unmatching voice sample 120 and facial image 130, e.g., a distance between voice embedding 124 and image embedding 134 of a matching voice sample 120 and facial image 130 is less than a distance between the voice embedding 124 and the image embedding 134 of an unmatching voice sample 120 and facial image 130. Other training methods may be used, for example using cross entropy classification, e.g., training an extra classification head so that each embedding is leading a classifier to predict a correct label.

In some embodiments, triplet training may be used to train voice-face matching model 142. A triplet may include a single voice sample 120 and two facial images 130, one that matches voice sample 120 and one that does not match voice sample 120. Other formats of triplets may be used, for example triplets including a single facial image 130 and two voice samples 120, one that matches facial image 130 and one that does not match facial image 130. The loss function calculated by VFM loss calculation module 140 may be used in the training process to adjust weights and other parameters in voice encoder 122 and face encoder 132 (in a backpropagation or gradient descent process) to decrease the distance between the latent vectors generated by the two encoders for the voice sample 120 and facial image 130 of the same person, and increase the distance between the latent vectors generated by the two encoders for voice sample 120 of the anchor person and facial image 130 of a different person.

An exemplary loss function may be:

$$loss = {\sum }_{k} max ( {‖ {emb}_{voice} ( {v}_{i}^{k} ) - {emb}_{face} ( {f}_{i}^{k} ) ‖}^{2} - {‖ {emb}_{voice} ( {v}_{i}^{k} ) - {emb}_{face} ( {f}_{j}^{k} ) ‖}^{2} + α , 0 ) \qquad ( Equation 1 )$$

Where:

$$( {v}_{i}^{k} , {f}_{i}^{k} , {f}_{j}^{k} )$$

is a triplet set used for training, where

$${v}_{i}^{k}$$

is the voice sample of the first person (e.g., a vector of real or imaginary values representing digital samples of sound),

$${f}_{i}^{k}$$

is the facial image (e.g., a matrix of values representing pixels of the image) of the first person, and

$${f}_{j}^{k}$$

is the facial image of the second, different, person. α ∈ R, is a triplet loss margin constant (e.g., a positive number), emb_{voice} (voice) is the voice embedding 124 generated by voice encoder 122, emb_{face} (face) is the image embedding 134 generated by image encoder 132.

In some embodiments, VFM loss calculation module 140 may calculate a weighted triplet loss function, based on the triplet, labels 144, and possibly based on the distance between the facial image of the first person (the speaker) and the facial image of the second person.

For example, the following loss function may be used (other functions may be used):

$$loss = {\sum }_{k} max ( {‖ {emb}_{voice} ( {v}_{i}^{k} ) - {emb}_{face} ( {f}_{i}^{k} ) ‖}^{2} - {‖ {emb}_{voice} ( {v}_{i}^{k} ) - {emb}_{face} ( {f}_{j}^{k} ) ‖}^{2} + α , 0 ) \cdot f ( d ( {emb}_{face}^{pre} ( {f}_{i}^{k} ) , {emb}_{face}^{pre} ( {f}_{j}^{k} ) ) ) \qquad ( Equation 2 )$$

### Where:

$${emb}_{face}^{pre} ( face )$$

is an image latent space vector generated by pretrained model such as a pretrained face recognition model, or other suitable trained facial images processing model.

$$d ( {emb}_{face}^{pre} ( {f}_{i}^{k} ) , {emb}_{face}^{pre} ( {f}_{j}^{k} ) )$$

is a distance between the image latent space vectors generated by the pretrained model for the facial image of the first person

$${emb}_{face}^{pre} ( {f}_{i}^{k} )$$

and the facial image of the second person

$${emb}_{face}^{pre} ( {f}_{j}^{k} ) .$$

For example, the distance may equal the Euclidian distance between

$${emb}_{face}^{pre} ( {f}_{i}^{k} ) and {emb}_{face}^{pre} ( {f}_{j}^{k} ) ,$$

or the inverse of the cosine similarity measure, e.g.,

$$d ( {emb}_{face}^{pre} ( {f}_{i}^{k} ) , {emb}_{face}^{pre} ( {f}_{j}^{k} ) ) = 1 - {cosine}_{similarity} ( {emb}_{face}^{pre} ( {f}_{i}^{k} ) , {emb}_{face}^{pre} ( {f}_{j}^{k} ) ) .$$

Other distance metrics may be used. f(x) is a non-decreasing function, e.g., a sigmoid.

As opposed to the loss function of Equation 1, an example loss function according to embodiments of the invention, e.g., Equation 2, is multiplied by the distance between the faces of the first person and the second person in the triplet. Thus, the loss value increases as the distance increases, e.g., as the difference between the faces increases, and decreases as the distance decreases, e.g., as the similarity between the two faces increases. Thus, the effect of triplets that include similar faces on the training process, e.g., on the values of the weights of voice encoder 122 and image encoder 132, is lower than the effect of triplets that include less similar faces. Thus, the loss function of Equation 2 may give less weight to triplets with similar looking faces than to less similar faces. According to embodiments of the invention, if a triplet includes similar faces, and the loss function does not consider this similarity, as in the loss function of Equation 1, the system may train voice encoder 122 and image encoder 132 to increase the distance between a voice sample and an image of a face that is similar to the face of the person whose voice sample is used in the triplet. This may erroneously adjust the weights of voice encoder 122 and image encoder 132 and adversely affect the training. In contrary to that, the loss function of Equation 2 increases as the similarity between the two faces in the triplet decreases, thus giving more weight in the training process to triples that include less similar faces comparing with triplets that include more similar faces. Other loss functions may be used, e.g., angular penalty softmax losses.

According to embodiments of the invention, it may be assumed that, as a result of the training, the cosine similarity (or other metric used for measuring similarity) between voice embeddings 124 and image embeddings 134 from images of the same person or images of similar persons is greater than cosine similarity between voice embeddings 124 and image embeddings 134 from images of different, less similar appearing, people.

Mapping network 150 may be configured to transform image embedding 134 and voice embedding 124 into an intermediate latent vector 160, which is the w vector of StyleGAN 170. In some embodiments, mapping network 150 may include a transformer network, however, other types of networks can be used for implementing mapping network 150. It is noted that the naïve approach of providing image embedding 134 directly to StyleGAN 170, as is being performed with other image decoders or traditional GANs may not operate well, since while image decoders or traditional GANs receive the latent vector through their input layer, in a StyleGAN the input layer is omitted and the StyleGAN uses the intermediate latent space vector w to control style at each point in the generator model. Thus, mapping network 150 is required in order to convert image embedding 134 to intermediate latent space vector 160.

According to embodiments of the invention, during training, image embedding 134 or voice embedding 124 may be provided to mapping network 150 which may generate an intermediate latent vector 160, which is the w vector of StyleGAN 170. Intermediate latent vector 160 may be provided to StyleGAN 170 to generate a reconstructed or generated facial image 180 of a speaker. The pipeline of image encoder 132, mapping network 150 and StyleGAN 170 may be referred to herein as the face-to-face pipeline, and the pipeline of voice encoder 122, mapping network 150 and StyleGAN 170 may be referred to herein as the voice-to-face pipeline. When using the face-to-face pipeline, loss calculation module 190 may calculate a loss function for training mapping network 150 and optionally for training image encoder 132, in a backpropagation or gradient descent process to minimize a distance measure between facial image 130 (the input image) provided to image encoder 132 and generated facial image 180. When using the voice-to-face pipeline, loss calculation module 190 may calculate a loss function for training mapping network 150 and optionally for training voice encoder 122, in a backpropagation or gradient descent process to minimize a distance measure between facial image 130 (the input image) that is matching voice sample 120 (e.g., originate from the same person) provided to voice encoder 122 and generated facial image 180. The loss function used for training mapping network 150, and optionally for training image encoder 132, may include one or more of image reconstruction losses and/or pixel-wise distances, such as:
L1 distance similarity loss between facial image 130 provided to image encoder 132 (or associated with voice sample 120 provided to voice encoder 122) and the reconstructed or generated facial image 180, to generally measure or estimate pixel-wise similarity.
Learned perceptual image patch similarity (LPIPS) loss for perceptual similarity. LPIPS generally calculates or estimates perceptual similarity between two images by computing the similarity between the activations of two image patches for some pre-defined network. A low LPIPS score may indicate that image patches are perceptually similar.
L_sim or Similarity loss, which is a generalized form of an identity loss, that explicitly encourages mapping network 150 to minimize the cosine similarity between the feature embeddings, e.g., features calculated by a dedicated and pretrained facial image encoder network, of reconstructed image 180 and facial image 130.

According to some embodiments, voice face matching network 142 and mapping network 150 may be trained together. For example, jointly training voice face matching network 142 and mapping network 150 may include training alternately one of voice face matching network 142 or mapping network 150 (possibly together with image encoder 132) in a single training step or iteration, and deciding, for a specific training step or iteration, whether to train voice face matching network 142 or mapping network 150, or both (and possibly image encoder 132 or voice encoder 122). For example, at the beginning of an iteration, system 100 may select randomly or pseudo randomly, or by other statistical regime, whether to train voice face matching network 142 or mapping network 150 at that iteration. In some embodiments, probabilities for selecting whether to train voice-face matching network 142 or mapping network 150 may be hyperparameters that may be scheduled and set at the beginning of the whole training process. In some embodiments, system 100 may select whether to train voice-face matching network 142 or mapping network 150 in an iteration based on convergence of the loss functions. For example, if the loss function of voice-face matching network 142 is higher than the loss function of the face-to-face pipeline, than system 100 may select to train the voice-face matching network 142 in a next iteration, and vice-versa. Other criteria may be used.

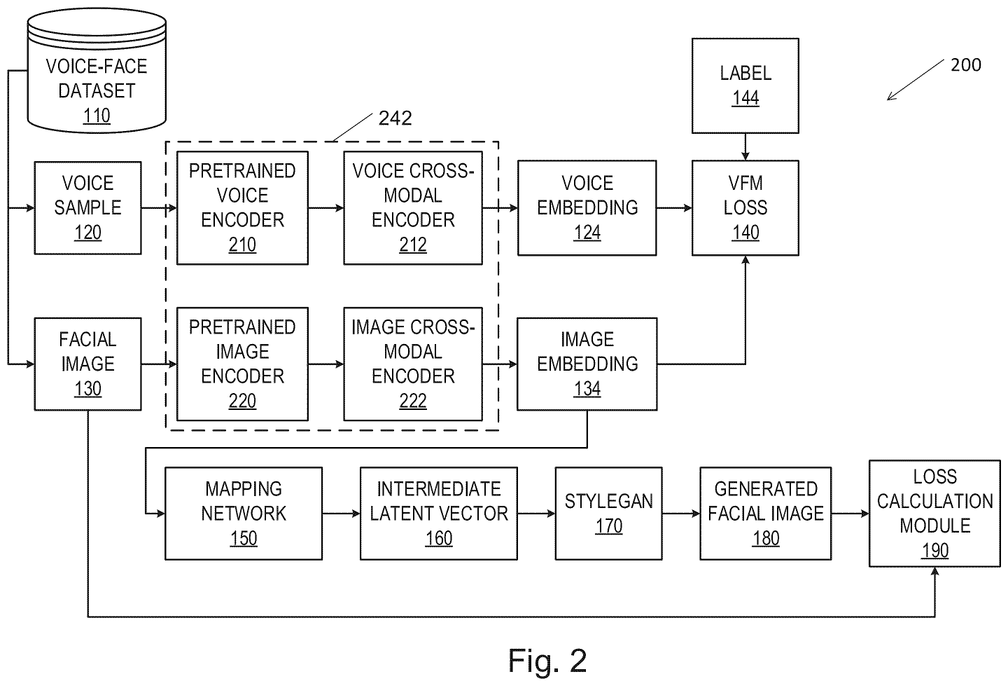

Reference is made to FIG. 2, which depicts a system 200 for training voice-face matching model 242 and a mapping network 150, according to embodiments of the invention. It should be understood in advance that the components, and functions shown in FIG. 2 are intended to be illustrative only and embodiments of the invention are not limited thereto. While in some embodiments the system of FIG. 2 is implemented using systems as shown in FIG. 8, in other embodiments other systems and equipment can be used.

System 200 may be very similar to system 100, with a slightly different implementation of voice-face matching model 242, which includes instead of a single voice encoder 122, a pretrained voice encoder 210 followed by a voice cross-modal encoder 212, and instead of image encoder 132, a pretrained image encoder 220 followed by an image cross-modal encoder 222. Pretrained voice encoder 210 and pretrained image encoder 220, as their name suggests, may be an already trained, off-the-shelf or propriety networks, trained to generate voice embeddings and image embeddings, respectively, for various other applications such as speaker recognition for voice and face recognition for images. Other pretrained networks may be used. According to some embodiments, in the training of system 200, that is performed similarly to the training of system 100 described hereinabove, only voice cross-modal encoder 212 and image cross-modal encoder 222 parts of voice-face matching model 242 may be trained. According to some embodiments, all modules of 242 may be trained, however, the training of pretrained voice encoder 210 and pretrained image encoder 220 may be easier (e.g., may require less computational power compared with the training of system 100) since both encoders are pretrained. Thus, training of system 200 may become simpler, quicker, more efficient and less computationally intensive than the training of system 100.

It is noted with reference to both system 100 and system 200, that in some embodiments voice-face matching model 142 and 242 may be pretrained (e.g., trained in a separate process prior to training system 100) and thus, in some embodiments in the training process only mapping network 150 may be trained.

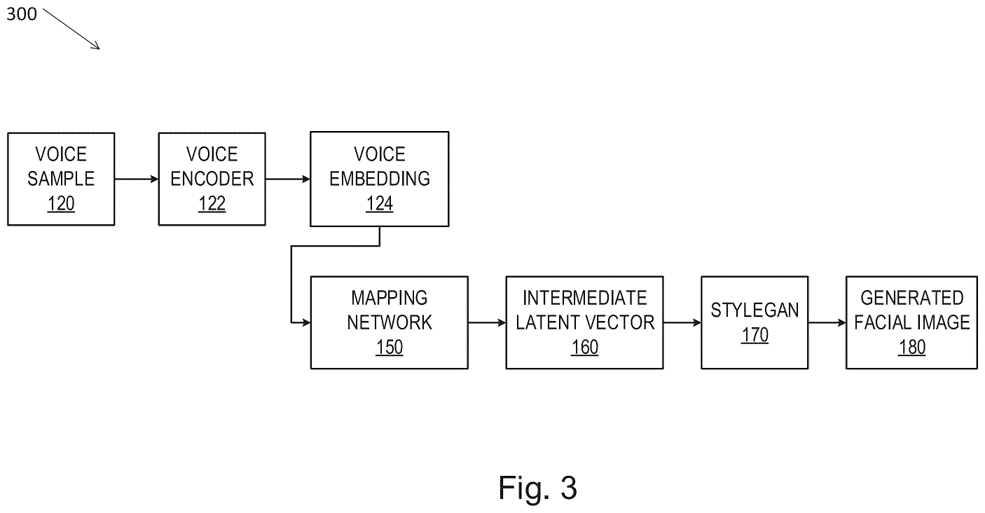

Reference is made to FIG. 3, which depicts a system 300 for reconstructing a facial image of a speaker from a voice sample of the speaker, according to embodiments of the invention. It should be understood in advance that the components and functions shown in FIG. 3 are intended to be illustrative only and embodiments of the invention are not limited thereto. While in some embodiments the system of FIG. 3 is implemented using systems as shown in FIG. 8, in other embodiments other systems and equipment can be used.

System 300 may include some of the elements of system 100 after training, and specifically trained voice encoder 122 and trained mapping network 150. System 100 may further include the same StyleGAN 170 used for training. During inference, system 300 may obtain or receive a voice sample 120 of the speaker and provide the voice sample 120 of the speaker to trained voice encoder 122 to generate a voice embedding 124 of the speaker. As described with reference to FIG. 1, voice encoder 122 may be trained to provide a voice embedding 124 that matches an image embedding 134 of the facial image of the speaker, e.g., such that a distance measure (such as the Euclidean distance measure) between voice embedding 124 and image embedding 134 is below a threshold or a similarity measure (such as the cosine similarity measure) above a threshold. Voice embedding 124 may be provided to trained mapping network 150, to generate an intermediate latent vector 160, also referred to as the w vector for StyleGAN 170. Intermediate latent vector 160 may be provided to StyleGAN 170 that may generate or reconstruct the facial image 180 of the speaker. The pipeline of voice encoder 122, mapping network 150 and StyleGAN 170 may be referred to herein as the voice-to-face pipeline.

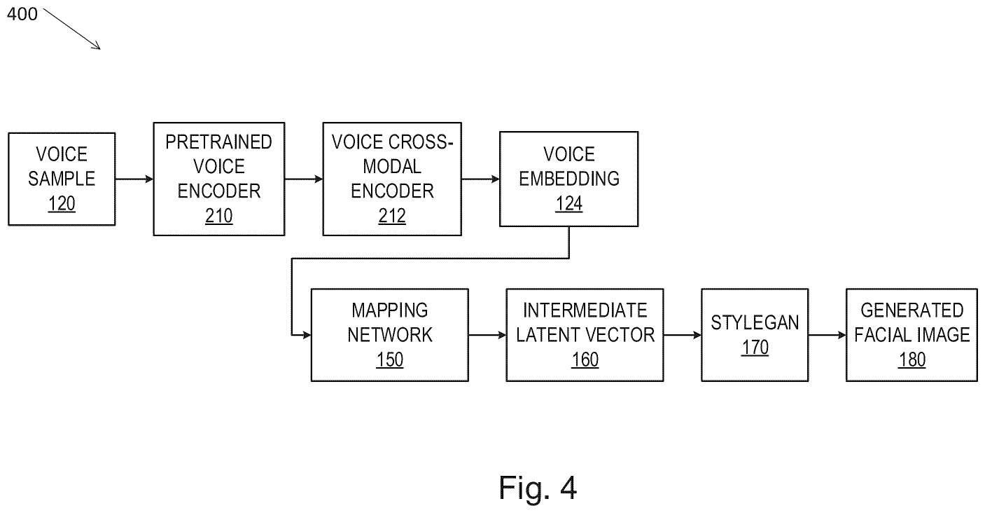

Reference is made to FIG. 4, which depicts a system 400 for reconstructing a facial image of a speaker from a voice sample of the speaker, according to embodiments of the invention. It should be understood in advance that the components, and functions shown in FIG. 4 are intended to be illustrative only and embodiments of the invention are not limited thereto. While in some embodiments the system of FIG. 4 is implemented using systems as shown in FIG. 8, in other embodiments other systems and equipment can be used. System 400 is very similar to system 300 in structure and operation, only system 400 includes, instead of a single voice encoder 122, a pretrained voice encoder 210 followed by a voice cross-modal encoder 212, which are trained as described with reference to FIG. 2.

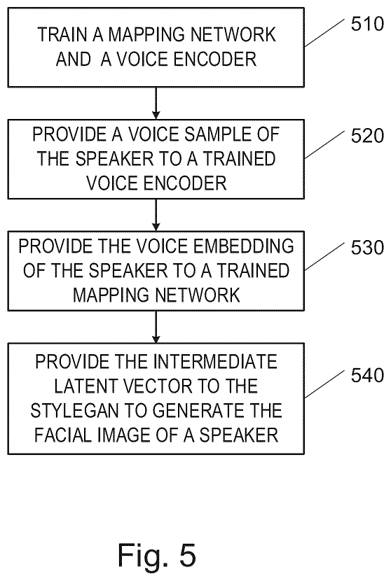

Reference is now made to FIG. 5, which is a flowchart of a method for reconstructing a facial image of a speaker from a voice sample of the speaker, according to embodiments of the invention. While in some embodiments the operations of FIG. 5 are carried out using systems as shown in FIGS. 1-4 and 8, in other embodiments other systems and equipment can be used.

In operation 510, a processor (e.g., processor 705 depicted in FIG. 8 executing code to carry out the method for reconstructing a facial image of a speaker from a voice sample of the speaker according to embodiments of the present invention) may train a mapping network and a voice encoder, such as mapping network 150 and voice encoder 132, or voice cross-modal encoder 212, as disclosed herein. In some embodiments, the mapping network and the voice encoder may be jointly trained together with an image encoder (e.g., image encoder 132 or an image cross-modal encoder 222) using a training dataset of matching and unmatching facial images and voice samples. The voice encoder and the image encoder may be trained so that a distance between the voice embedding and the image embedding of a matching voice sample and facial image is less than the distance between the voice embedding and the image embedding of an unmatching pair of voice sample and facial image. The mapping network and possibly the image encoder or voice encoder may be trained to minimize a reconstruction loss and/or pixel-wise distance between an input image and the generated facial image of a speaker, where the reconstruction loss and/or pixel-wise distance may be selected from (e.g., is a combination of one or more of) the following loss terms: L1 loss. L2 loss, a distance measure between the facial image provided to the image encoder (when training in the face-to-face pipeline) or the facial image matching the voice sample provided to the voice encoder (when training in the voice-to-face pipeline) and the reconstructed facial image, learned perceptual image patch similarity (LPIPS) loss and Lsimor Similarity loss. In some embodiments the reconstruction loss may be a weighed sum of the loss terms listed hereinabove. In some embodiments the processor may receive, obtain or use a pretrained voice-face matching network 142 or 242, and train mapping network as disclosed herein.

In operation 520, the processor may provide a voice sample of the speaker to the trained voice encoder to generate a voice embedding of the speaker. In operation 530, the processor may provide the voice embedding of the speaker to a trained mapping network to generate an intermediate latent vector for a StyleGAN from the voice embedding. In operation 540, the processor may provide the intermediate latent vector to the StyleGAN to generate or reconstruct the facial image of a speaker.

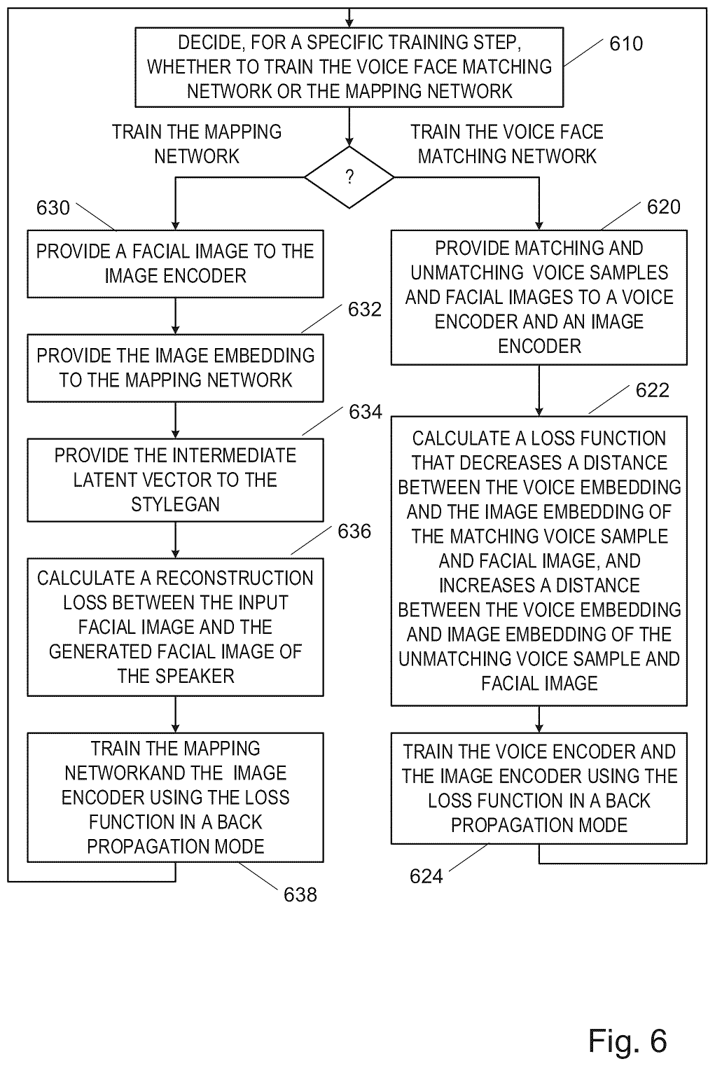

Reference is now made to FIG. 6, which is a flowchart of a method for jointly training a voice-face matching model and a mapping network, according to embodiments of the invention. While in some embodiments the operations of FIG. 6 are carried out using systems as shown in FIGS. 1-4 and 9, in other embodiments other systems and equipment can be used.

In operation 610, a processor (e.g., processor 705 depicted in FIG. 8 executing code to carry out the method for jointly training a voice-face matching model and a mapping network according to embodiments of the present invention) may decide or determine, for a specific training step or iteration, whether to train the voice face matching network or the mapping network, or both. For example, the processor may determine whether to train the voice face matching network or the mapping network, or both randomly or pseudo randomly or by other statistical regime. In some embodiments, probabilities for selecting whether to train voice face matching network or mapping network or both may be hyperparameters that may be set at the beginning of the whole training process and may follow some an arbitrary schedule. If the processor determines or decides at operation 610 to train the voice face matching network, then the method may continue to operation 620. If the processor determines or decides at operation 610 to train the mapping network, then the method may continue to operation 630. If the processor determines or decides to train both, the method may continue to operations 610 and 620 in parallel. Is some embodiments, operation 610 is omitted and the processor trains both the voice face matching network and the mapping network in parallel by default.

In operation 620, the processor may provide matching and unmatching voice samples and facial images to a voice encoder and an image encoder. The matching and unmatching voice samples and facial images may be provided in pairs or triplets of matching and unmatching voice samples and facial images, as disclosed herein. In operation 622, the processor may calculate a loss function that decreases a distance between the voice embedding and the image embedding of the matching voice sample and facial image, and increases a distance between the voice embedding and image embedding of the unmatching voice sample and facial image. In operation 624, the processor may train the voice encoder and the image encoder using the loss function in a backpropagation or gradient descent process.

In operation 630, the processor may provide a facial image to the image encoder, to generate an image embedding. In operation 632, the processor may provide the image embedding to the mapping network, to generate an intermediate latent vector. In operation 634, the processor may provide the intermediate latent vector to the StyleGAN to generate or reconstruct a generated or reconstructed facial image of the speaker. In operation 636, the processor may calculate a reconstruction loss between the input facial image and the generated or reconstructed facial image of the speaker. In operation 638, the processor may train the mapping network and possibly the image encoder using the loss function in a backpropagation or gradient descent process. Training of the mapping network and the voice face matching network may continue until a predetermined stopping criteria is met, e.g., in terms of accuracy of face reconstruction.

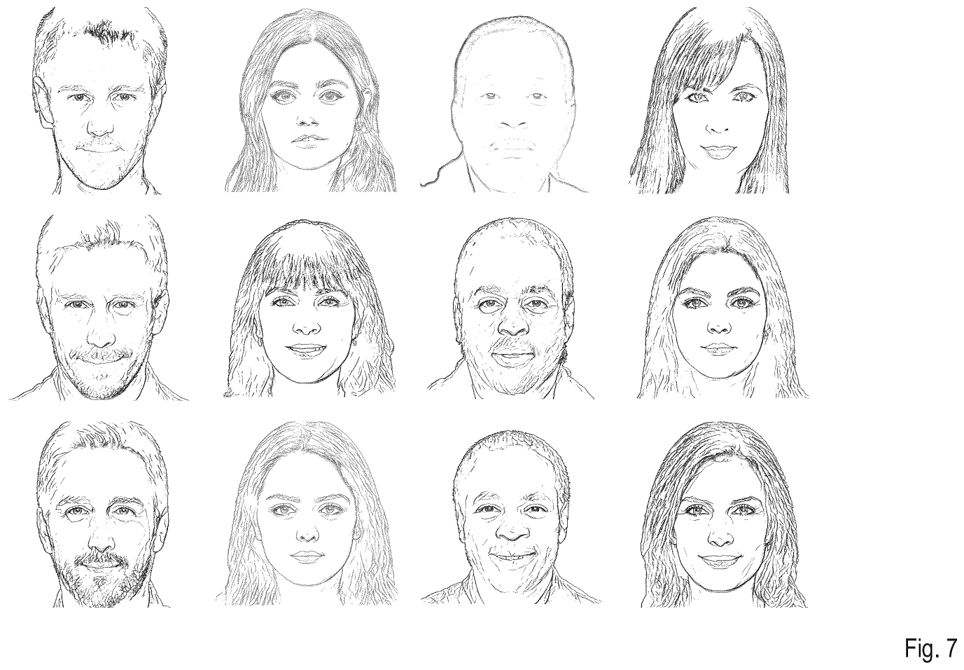

Reference is now made to FIG. 7, which depicts facial images reconstructed from a voice sample of the speaker, according to embodiments of the invention. Column #1of FIG. 7 depicts the real face of the speaker and columns #2-4 depict faces generated with using embodiments of the invention. The top row in FIG. 7 depicts the real face of the speaker, the middle row depicts faces reconstructed using the face-to-face pipeline, and the bottom row faces reconstructed using the voice-to-face pipeline. As can be seen, the bottom reconstructed faces preserve significant characteristics of the original faces, including gender, age, ethnicity and general facial structure. In addition, the quality of the faces reconstructed by the voice-to-face pipeline is high and the faces are detailed and realistic.

FIG. 8 shows a high-level block diagram of an exemplary computing device which may be used with embodiments of the present invention. Computing device 700 may include a controller or processor 705 that may be or include, for example, one or more central processing unit processor(s) (CPU), one or more Graphics Processing Unit(s) (GPU), a chip or any suitable computing or computational device, an operating system 715, a memory 720, a storage 730, input devices 735 and output devices 740. Each of modules and equipment such as voice encoder 122, image encoder 132, pretrained voice encoder 210, voice cross-modal encoder 212, pretrained image encoder 220, image cross-modal encoder 222, mapping network 150 and StyleGAN 170 as shown in FIGS. 1-4 and other modules or equipment mentioned herein may be or include, or may be executed by, a computing device such as included in FIG. 8 or specific components of FIG. 8, although various units among these entities may be combined into one computing device.

Operating system 715 may be or may include any code segment designed and/or configured to perform tasks involving coordination, scheduling, supervising, controlling or otherwise managing operation of computing device 700, for example, scheduling execution of programs. Memory 720 may be or may include, for example, a Random Access Memory (RAM), a read only memory (ROM), a Dynamic RAM (DRAM), a volatile memory, a non-volatile memory, a cache memory, or other suitable memory units or storage units. Memory 720 may be or may include a plurality of possibly different memory units. Memory 720 may store for example, instructions to carry out a method (e.g., code 725), and/or data such as model weights, etc.

Executable code 725 may be any executable code, e.g., an application, a program, a process, task or script. Executable code 725 may be executed by processor 705 possibly under control of operating system 715. For example, executable code 725 may when executed carry out methods according to embodiments of the present invention. For the various modules and functions described herein, one or more computing devices 700 or components of computing device 700 may be used. One or more processor(s) 705 may be configured to carry out embodiments of the present invention by for example executing software or code.

Storage 730 may be or may include, for example, a hard disk drive, a floppy disk drive, a Compact Disk (CD) drive, or other suitable removable and/or fixed storage unit. Data such as instructions, code, video, images, voice samples, training data, model weights and parameters etc. may be stored in a storage 730 and may be loaded from storage 730 into a memory 720 where it may be processed by processor 705. Some of the components shown in FIG. 8 may be omitted.

Input devices 735 may be or may include for example a mouse, a keyboard, a touch screen or pad or any suitable input device. Any suitable number of input devices may be operatively connected to computing device 700 as shown by block 735. Output devices 740 may include displays, speakers and/or any other suitable output devices. Any suitable number of output devices may be operatively connected to computing device 700 as shown by block 740. Any applicable input/output (I/O) devices may be connected to computing device 700, for example, a modem, printer or facsimile machine, a universal serial bus (USB) device or external hard drive may be included in input devices 735 or output devices 740. Network interface 750 may enable device 700 to communicate with one or more other computers or networks. For example, network interface 750 may include a wired or wireless NIC.

Embodiments of the invention may include one or more article(s) (e.g. memory 720 or storage 730) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

One skilled in the art will realize the invention may be embodied in other specific forms using other details without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein. In some cases well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” can include, for example, “multiple” or “two or more”. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A method for reconstructing a facial image of a speaker from a voice sample of the speaker, the method comprising:
providing the voice sample of the speaker to a trained voice encoder to generate a voice embedding of the speaker, wherein the voice encoder is trained to provide a voice embedding that matches an image embedding of an input facial image of the speaker;
providing the voice embedding of the speaker to a trained mapping network to generate an intermediate latent vector, wherein the mapping network is trained to generate an intermediate latent vector for a StyleGAN from the voice embedding; and
providing the intermediate latent vector to the StyleGAN to generate the facial image of a speaker.

2. The method of claim 1, comprising:
jointly training the mapping network, the voice encoder and an image encoder configured to generate an image embedding from a facial image, using a training dataset of matching and unmatching facial images and voice samples,
wherein the voice encoder and the image encoder are trained so that a distance between the voice embedding and the image embedding of a matching voice sample and facial image is less than the distance between the voice embedding and the image embedding of an unmatching voice sample and facial image.

3. The method of claim 2, wherein the mapping network is trained to minimize a reconstruction loss between an input image and the generated facial image of a speaker.

4. The method of claim 3, wherein the reconstruction loss includes at least one of: a distance measure between the facial image provided to the image encoder and the reconstructed facial image, learned perceptual image patch similarity (LPIPS) loss and Similarity loss.

5. The method of claim 2, wherein the voice encoder and the image encoder are trained using a loss function that decreases a distance between the voice embedding and the image embedding of the matching voice sample and facial image, and increases a distance between the voice embedding and image embedding of the unmatching voice sample and facial image.

6. The method of claim 2, wherein jointly training the voice face matching network and the mapping network comprises training one of the voice face matching network or the mapping network in a single training step, and deciding, for a specific training step, whether to train the voice face matching network or the mapping network.

7. The method of claim 2, wherein the voice encoder comprises a pretrained voice encoder and a trainable voice cross-modal encoder.

8. The method of claim 2, wherein the image encoder comprises a pretrained image encoder and a trainable image cross-modal encoder.

9. A method for generating a reconstructed facial image of a speaker from a voice sample of the speaker, the method comprising:
in a training stage:
obtaining a pretrained voice-face matching network comprising a voice encoder configured to generate a voice embedding from a voice sample and an image encoder configured to generate an image embedding from an input facial image, wherein the voice encoder and the image encoder are trained so that a distance between the voice embedding and the image embedding of a matching voice sample and facial image is less than the distance between the voice embedding and the image embedding of an unmatching voice and facial image;
training a mapping network to generate an intermediate latent vector for a StyleGAN from the image embedding generated by the image encoder, so that the StyleGAN generates the reconstructed facial image;
during inference:
providing the voice sample of the speaker to the trained voice encoder to generate a voice embedding of the speaker; and
generating an intermediate latent vector from the voice embedding of the speaker by providing the voice embedding of the speaker to the trained mapping network; and
providing the intermediate latent vector generated from the voice embedding of the speaker to the StyleGAN, so that the StyleGAN generates the facial image of the speaker.

10. The method of claim 9, wherein the mapping network is trained to minimize a distance measure between the facial image provided to the image encoder and the reconstructed facial image.

11. The method of claim 9, wherein the mapping network is trained using at least one of image reconstruction losses and pixel-wise distance between the facial image provided to the image encoder and the reconstructed facial image.

12. A system for reconstructing a facial image of a speaker from a voice sample of the speaker, the system comprising:
a memory; and
a processor configured to:
provide the voice sample of the speaker to a trained voice encoder to generate a voice embedding of the speaker, wherein the voice encoder is trained to provide a voice embedding that matches an image embedding of an input facial image of the speaker;
provide the voice embedding of the speaker to a trained mapping network to generate an intermediate latent vector, wherein the mapping network is trained to generate an intermediate latent vector for a StyleGAN from the voice embedding; and
provide the intermediate latent vector to the StyleGAN to generate the facial image of a speaker.

13. The system of claim 12, wherein the processor is configured to:
jointly train the mapping network, the voice encoder and an image encoder configured to generate an image embedding from a facial image, using a training dataset of matching and unmatching facial images and voice samples,
wherein the processor is configured to train the voice encoder and the image encoder so that a distance between the voice embedding and the image embedding of a matching voice sample and facial image is less than the distance between the voice embedding and the image embedding of an unmatching voice sample and facial image.

14. The system of claim 13, wherein the processor is configured to train the mapping to minimize a reconstruction loss between an input image and the generated facial image of a speaker.

15. The system of claim 14, wherein the reconstruction loss includes at least one of: a distance measure between the facial image provided to the image encoder and the reconstructed facial image, learned perceptual image patch similarity (LPIPS) loss and Similarity loss.

16. The system of claim 13, wherein the processor is configured to train the voice encoder and the image encoder using a loss function that decreases a distance between the voice embedding and the image embedding of the matching voice sample and facial image, and increases a distance between the voice embedding and image embedding of the unmatching voice sample and facial image.

17. The system of claim 13, wherein the processor is configured to jointly train the voice face matching network and the mapping network by training one of the voice face matching network or the mapping network in a single training step, and deciding, for a specific training step, whether to train the voice face matching network or the mapping network.

18. The system of claim 13, wherein the voice encoder comprises a pretrained voice encoder and a trainable voice cross-modal encoder.

19. The system of claim 13, wherein the image encoder comprises a pretrained image encoder and a trainable image cross-modal encoder.
